(19) United States
(12) Patent Application Publication
(10) Pub. No.: US 2025/0214478 A1
(43) Pub. Date: Jul. 3, 2025

(54) EDGE-BASED MANAGEMENT OF ELECTRIC VEHICLE CHARGING SESSIONS AND RELATED METHODS

(71) Applicant: PowerFlex Systems, LLC, San Diego, CA (US)

(72) Inventors: Ted LEE, San Marino, CA (US); Florentina HOFBAUER, Chula Vista, CA (US); Jonathan KOSER, Holmen, WI (US); Javier Nicolás LEDESMA, Cordoba (AR)

(21) Appl. No.: 18/977,354

(22) Filed: Dec. 11, 2024

Related U.S. Application Data
(60) Provisional application No. 63/615,653, filed on Dec. 28, 2023.

(51) Int. Cl. B60L 53/68; B60L 53/63; B60L 53/64; B60L 53/67; G06Q 10/0631

(52) U.S. Cl. CPC B60L 53/68; B60L 53/63; B60L 53/64; G06Q 10/0631; B60L 53/67

(57) ABSTRACT

Certain aspects of the present disclosure provide techniques for managing electric vehicle charging sessions. In examples, techniques may include receiving, at an edge computing device associated with a charging site, a connection status of an electric vehicle from a charging station, wherein the edge computing device is located on-site at the charging site; initiating, by the edge computing device, a charging session based on the connection status by creating a charging session record to be stored at the edge computing device; determining optimized charging parameters for the electric vehicle; sending the optimized charging parameters from the edge computing device to the charging station; logging usage information locally at the edge computing device for the charging session; and maintaining operation of the charging station during an interruption in network connectivity between the edge computing device and a cloud computing system by utilizing data stored locally at the edge computing device.

### CROSS-REFERENCE TO RELATED APPLICATIONS

This Application claims the benefit of and priority to U.S. Provisional Patent Application No. 63/615,653, filed on Dec. 28, 2023, the entire contents of which are hereby incorporated by reference.

### INTRODUCTION

Electric vehicle (EV) charging infrastructure is a rapidly growing field. EV charging stations typically rely on backend cloud systems to manage charging sessions. For example, when an EV connects to an EV charging station, the EV charging station sends a status update to a backend cloud system which then initiates and manages a charging session. The backend cloud system maintains databases of active charging sessions across multiple sites and sends charging parameters down to individual EV charging stations. This centralized cloud-based approach enables system-wide optimization and advanced features, but relies heavily on consistent connectivity.

This dependency on the consistent connectivity to a backend cloud system can lead to several issues, especially in areas with unreliable internet connectivity. When a connection to the backend cloud system is lost, the charging services provided by charging sites can degrade, leading to a poor driver experience and inefficient site utilization. For example, the EV charging stations may be forced to stop charging entirely or to revert to simple charging modes like alternating between charging ports or charging at a reduced charge rate. Furthermore, site outages that result from the loss of connection to the backend cloud system can have cascading effects on advanced centralized load management across fleets of distributed charging sites. As the EV charging infrastructure continues to expand, these problems are expected to become more pronounced.

### SUMMARY

In accordance with aspects of the present disclosure, a method is provided for managing electric vehicle charging sessions at a charging site. The method includes receiving a connection status of an electric vehicle supply equipment (EVSE) at an edge computing device associated with the charging site, creating or deleting a charging session at the edge computing device based on the connection status, storing charging session data at the edge computing device, and operating the charging site using the charging session data stored at the edge computing device when an internet connection between the edge computing device and a cloud computing system is interrupted.

In accordance with aspects of the present disclosure, a method is provided for managing electric vehicle charging sessions. The method includes: receiving, at an edge computing device associated with a charging site, a connection status of an electric vehicle from a charging station, wherein the edge computing device is located on-site at the charging site; initiating, by the edge computing device, a charging session based on the connection status by creating a charging session record to be stored at the edge computing device; determining optimized charging parameters for the electric vehicle based on at least one of: a detected electric vehicle capability, a charging station configuration, or an electricity availability constraint; sending the optimized charging parameters from the edge computing device to the charging station to control charging behavior; logging usage information locally at the edge computing device for the charging session; and maintaining operation of the charging station during an interruption in network connectivity between the edge computing device and a cloud computing system by utilizing the charging session record and the usage information stored locally at the edge computing device.

In accordance with aspects of the present disclosure, a method is provided for maintaining electric vehicle charging station operation during network communication outages using an edge computing system. The method includes: detecting, at an edge computing device located on-site at a charging station location, an interruption in network communication between the edge computing device and a cloud computing system; accessing, by the edge computing device, predefined communication outage policies stored locally in a data store at the edge computing device, wherein the accessing is in response to detecting the interruption; controlling, by the edge computing device, operation of a charging station during the interruption based on instructions included in the predefined communication outage policies, wherein the controlling includes making determinations on at least one of: handling new electric vehicle charging session requests received during the interruption; adapting or stopping existing active electric vehicle charging sessions during the interruption; processing payments for electric vehicle charging sessions; prioritizing between multiple electric vehicle charging sessions; or logging charging station usage data and diagnostic information at the edge computing device; detecting, at the edge computing device, restoration of the interrupted network communication; and resynchronizing electric vehicle charging data between the edge computing device and the cloud computing system.

Other aspects provide processing systems configured to perform the aforementioned methods as well as those described herein; one or more non-transitory, computer-readable mediums comprising instructions that, when executed by one or more processors of a processing system, cause the processing system to perform the aforementioned methods as well as those described herein; a computer program product embodied on a computer readable storage medium comprising code for performing the aforementioned methods as well as those described herein; and a processing system comprising means for performing the aforementioned methods as well as those described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts a computing environment for managing electric vehicle charging sessions using an edge computing architecture, according to aspects provided herein;

FIG. 2 depicts a software configuration for an edge environment, according to aspects provided herein;

FIGS. 3A-3C depict device configurations for the edge environment, according to aspects provided herein;

FIGS. 4A-4C depict hardware that may be utilized for the devices from FIGS. 3A-3C, according to aspects provided herein;

FIG. 5 depicts details of an edge session manager, according to aspects provided herein;

FIG. 6 depicts internal architecture and logic included within the edge session manager, according to aspects provided herein;

FIG. 7 depicts a cloud environment for aggregating and processing charging session data, according to aspects provided herein;

FIG. 8 depicts a flow diagram for enabling drivers to remotely initiate and manage charging sessions, according to aspects provided herein;

FIG. 9 depicts example data structures for representing charging session parameters and site configuration details, according to aspects provided herein;

FIG. 10 depicts an example flowchart illustrating a method for managing charging sessions upon electric vehicle connection, according to aspects provided herein;

FIGS. 11A-11B depict example flowcharts illustrating methods for maintaining functionality during network communication outages and subsequent restoration, according to aspects provided herein;

FIGS. 12-13 depict example flowcharts illustrating methods for managing charging sessions, according to aspects provided herein; and

FIG. 14 depicts components of a processing system implementing the edge environment, according to aspects provided herein.

### DETAILED DESCRIPTION

Aspects disclosed herein include systems and methods for edge-based management of electric vehicle (EV) charging sessions. Some aspects utilize an edge computing architecture that handles core charging session management functionalities on-site, allowing EV charging stations to operate even when backend connectivity is interrupted. Systems and methods for enabling EV charging infrastructure incorporating the same will be described in more detail, below.

To address connectivity limitations, aspects of the present disclosure may utilize an edge computing architecture for EV charging management. Utilizing this approach, a portion of the charging management functionalities can be offloaded or otherwise handled by an edge computing system located on-site at each charging location. Accordingly, a local data store at an edge computing site may maintain active charging sessions and site configuration details. Thus, having charging management functionalities at the edge may allow charging stations to function robustly even when connectivity to backend cloud systems and services is interrupted.

In certain aspects, the techniques described herein may advance the field of EV charging infrastructure management by enabling edge-based functionality for session handling, optimization, and resilient operations. In certain aspects, by shifting at least some charging management capabilities to an edge environment located on-site, charging stations can operate through network outages to reduce costs and improve driver experience.

In certain aspects, implementing adaptive session coordination and electricity balancing logic directly at an edge environment provides capabilities not readily achievable with traditional centralized, cloud-dependent architectures. In certain aspects, edge optimization considers local constraints and needs while reducing data transmission overheads. Further, configurable edge-based policies may allow session handling to proceed per site-specific priorities during communication degradations and/or outages. By complementing, rather than fully replacing, cloud functionality, in certain aspects, the techniques described herein may provide technical improvements in charging availability and optimization granularity, and provide an environment to safely upgrade one or more features of the edge environment and/or a charging site.

### Computing Environment

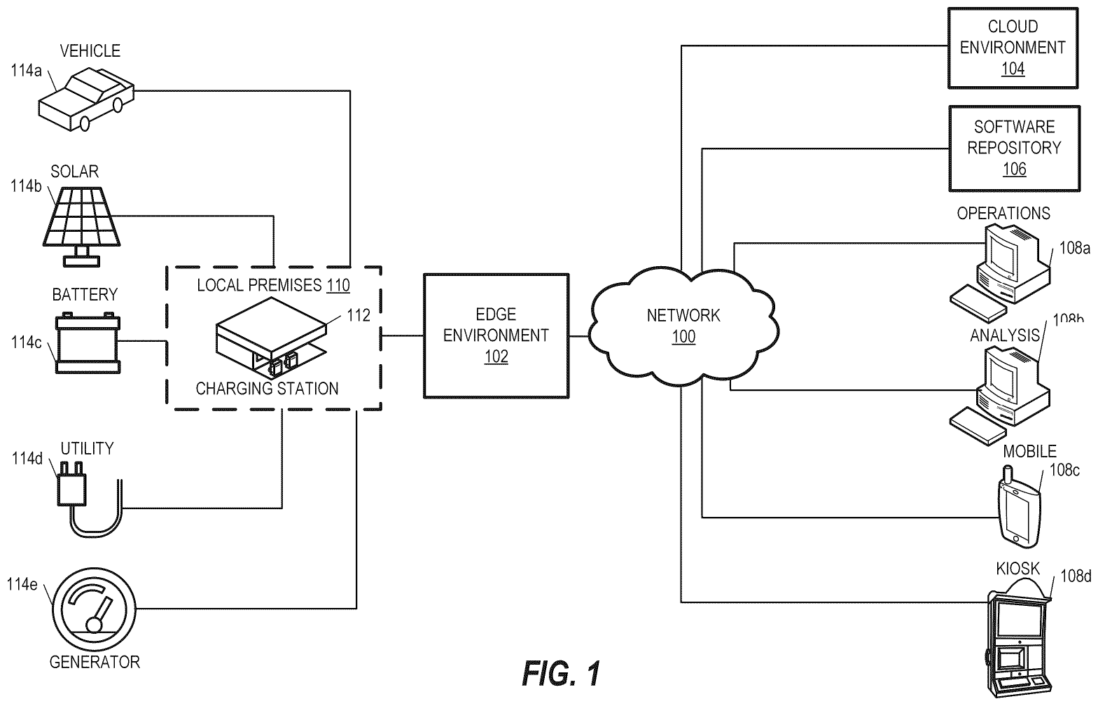

Referring now to the drawings, FIG. 1 depicts a computing environment for managing electric vehicle charging sessions and related data, according to aspects provided herein. As illustrated, the computing environment includes a network 100 that is coupled to an edge environment 102, a cloud environment 104, and a software repository 106. The network 100 may be configured as any wide area network (WAN, such as the internet, power network, cellular network, etc.), local network (e.g., LAN, Ethernet, Wireless-Fidelity, etc.), and/or peer-to-peer or personal area network (PAN, such as Zigbee, Bluetooth, wireline, etc.), for facilitating communication among the components described herein.

The edge environment 102 may include and/or be coupled with one or more charging stations 112, such as level 2 station and open charge point protocol (OCPP) station. Note that other types of charging stations are possible. Charging station 112 may be configured to charge one or more EVs and/or other electric devices. The charging station 112 may utilize any protocol of charging, such as open smart charging protocol (OSCP), open charge point interface (OCPI), ISO 15118, OpenADR, etc. and may represent previous generation (e.g., level 1) or next generation (e.g., beyond level 2) charging, as applicable. Similarly, the charging station 112 may represent a charging station that utilizes OCPP protocol, which may be configured with open-source communication standards for widespread compatibility with other OCPP-compliant software and devices. As will be understood, the charging station 112 can be expanded to other protocols. Generally, each charging station 112 may be referred to alternatively as an EV charging station or an electric vehicle supply equipment (EVSE).

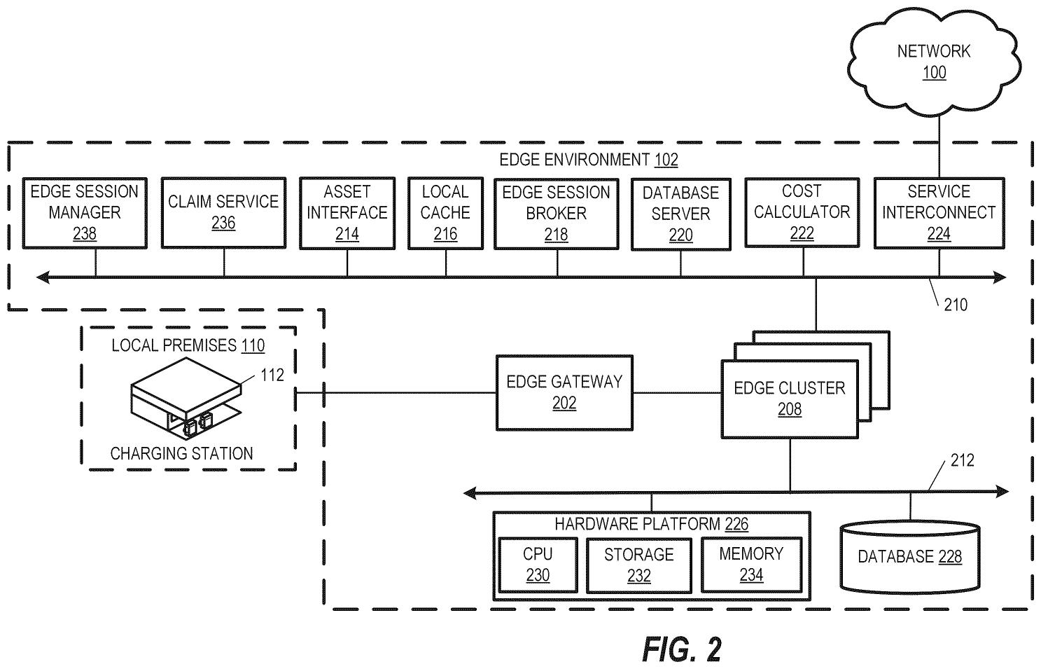

As described with reference to FIG. 2, the edge environment 102 may be configured as an interface between the charging station 112 and the network 100. Specifically, some aspects may be configured such that the computing power at one or more charging stations 112 may be controlled dynamically (e.g., increased or decreased, limited, etc.) and the edge environment 102 may be configured to provide fast processing of data, as well as processing when access to the network 100 may be limited.

The cloud environment 104 may be coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serve one or more charging stations 112.

Also coupled to the edge environment 102 are energy sources 114. The energy sources 114 may include a vehicle 114a, a solar device 114b, a battery 114c, a utility 114d (such as a coal plant, solar plant, wind farm, etc.), a generator 114e, and/or other sources of energy. While not an exhaustive list, the energy sources 114 may provide energy to the charging stations 112. In some aspects, the charging stations 112 may send excess energy back to the battery 114c and/or to the utility 114d. Regardless, the edge environment 102 may monitor and/or modify the energy received from the energy sources 114 to be properly utilized by the corresponding charging station 112.

Also coupled to the network 100 is a software repository 106. The software repository 106 may be configured as a platform to program, store, manage, control changes, etc., to software that is implemented in the edge environment and/or cloud environment. The software repository 106 may be configured as a proprietary service and/or may be provided by a third party, such as GitHub™.

Also depicted in FIG. 1 are ancillary devices 108. The ancillary devices 108 may include an operations device 108a, an analysis device 108b, a mobile device 108c, a kiosk 108d, and/or other devices. Specifically, the operations device 108a may be utilized to monitor and/or alter operations of the environment provided in FIG. 1. The analysis device 108b may analyze utilization, operation, charging, and/or other features of the computing environment. The mobile device 108c may represent an administrator device and/or a user device. As a user device, the mobile device 108c may initiate charging, payment, and/or perform other user-specific actions. As an administrator device, the mobile device 108c may perform administrative operations, analysis, and/or perform other actions. The kiosk 108d may be located at one of the charging stations 112 and/or remote therefrom and may provide user-specific actions, similar to that of the mobile device 108c. As will be understood, the ancillary devices 108 may each include a processor, a memory component, and/or other hardware and/or software for performing the functionality provided herein.

### Edge Environment

FIG. 2 depicts a software configuration for edge environment 102, according to aspects provided herein. As illustrated, the edge environment 102 may be coupled to the charging stations 112 via an edge gateway 202. Also included in the edge environment 102 are a neural autonomic transport system edge cluster 208, which is coupled to communication bus 210 and hardware bus 212. The communication bus 210 may be coupled to an asset interface 214, a local cache 216, an edge session broker 218, a database server 220, a cost calculator 222, and a service interconnect 224. Also coupled to communication bus 210 is claim service 236 and edge session manager 238. Similarly, the hardware bus 212 may be coupled to a hardware platform 226, which may include one or more processors, such as CPU 230, one or more storage components, such as storage component 232, one or more memories, such as memory component 234, and/or other hardware components. Also coupled to hardware bus 212 is a database 228.

The charging station 112 may be configured for serial bus communication, communication via a peer-to-peer communication protocol, such as Zigbee, and/or other wired or wireless communication protocol. The edge gateway 202 may be configured to receive data, such as electric charging data, price charge data, vehicle data, etc. from the charging station 112 and/or vehicles that are being charged. Additionally, the edge gateway 202 may be configured to abstract data received from the charging station 112 to remove protocol specific distinctions. Thus, data output from the edge gateway 202 may be protocol agnostic relative to the protocol of data utilized by the particular charging station 112. The edge gateway 202 may then send the data to the edge cluster 208.

The edge cluster 208 may be the central message center in various aspects. For example, when a user plugs a vehicle into a charging station 112, the edge cluster 208 receives data from the edge gateway 202, parses that data to access state data, and causes the state data to be sent to the database server 220. The edge cluster 208 may also receive the data and creates a session entry, which may be stored in the local cache 216. The edge cluster 208 may additionally send the session entry to the cloud environment 104. The edge session broker 218 may also receive data related to the new session and will reach out to the database server 220 to access additional session data and solve for a charge curve.

The edge session broker 218 may then send this data to the edge cluster 208, which may be sent to the edge gateway 202 for potentially sending back to one or more charging stations 112. Information that may be reported might include current delivered over time (e.g., amperes), total energy delivered (e.g., kWh), etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy sources 114.

It should be understood that, in certain aspects, the edge cluster 208 is configured such that any message received by the edge cluster 208 may also be sent to the cloud environment 104, for example, if there is an interested subscriber. If not, the data may remain with the edge cluster 208. Thus, if a user of the mobile device 114c (of FIG. 1) desires to claim a session, the mobile device 114c does not need to access the edge environment 102 directly. Instead, the mobile device 114c may connect with the cloud environment 104 (e.g., via an application programming interface (API)), which sends a message to the edge cluster 208 with an instruction to claim the session. As will be understood, the service interconnect 224 may be configured for establishing an HTTP, TCP, and/or other type of communication with the cloud environment 104 via the network 100.

Additionally, the hardware platform 226 may represent any hardware for facilitating the processes and actions described herein. Specifically, the CPU 230 may be configured as any processor for executing instructions received from the hardware platform 226. The storage component 232 may be configured as long term storage, such as a hard drive or the like. The memory component 234 may include any of various types of read or access memory or the like. The database 228 may be configured for additional storage and may be housed with the other hardware and/or elsewhere.

In certain aspects, the claim service 236 can be a module within the edge environment 102 for managing session reservation and access control. The claim service 236 can interface with various front-end driver claim methods like apps, RFID cards, and on-site kiosks to initiate validated charging sessions. During a driver charging session claim, the claim service 236 can receive reservation details from entry points like a mobile application. Information supplied may include the driver identity, requested station, energy amount needed, any personalized charging parameters, or the like. In certain aspects, the claim service 236 can further verify the identity and credentials according to stored access policies before proceeding.

Leveraging current site status and session data from the edge session manager 238, the claim service 236 can determine available electrical capacity for fulfilling a charge request. Constraints around station availability, renewable energy schedules, electrical panel loads, and existing sessions can be assessed by one or more components of the edge environment 102 and an optimized set of charging parameters can be generated and reserved for the claimant. Thus, the claim service 236 manages details of expected future sessions for reserved charging stations to ensure capacity. Actual charging is activated once the driver physically connects their electric vehicle. The claim service 236 can release unused reservations after a configurable expiration period. Secondary authentication methods like RFID tap can provide on-site identity verification in some scenarios before energizing.

Integrating the claim service 236 directly at the edge level (e.g., edge environment 102) may enable reduced latency for initiating sessions compared to cloud-centric architectures. Response times for claim requests may be improved by leveraging local data stores (e.g., local cache 216/database 228) and reserved capacity calculations. Identity, policy enforcement, and charging parameter determination may also benefit from edge-based handling due to proximity with charging stations 112. As infrastructure grows, cloud scaling limitations and bandwidth constraints may be avoided by having claim management functionality residing at the edge environment 102.

In examples, the edge session manager 238 can be a software component running on the edge computing system that handles charging management responsibilities. In certain aspects, the charging management responsibilities include monitoring connected charging stations, initiating and tracking charging sessions, optimizing electricity allocation across multiple vehicles, maintaining resilient operation, or any combination thereof. More specifically, the edge session manager 238 (e.g., as part of an edge computing device associated with a charging site) may receive real-time connection status updates from connected charging stations at the site as vehicles plug and unplug. Based on this information, the edge session manager 238 may create and/or delete charging session(s) or charging session record(s) locally as needed. Active charging sessions (as well as any charging session data) may be stored or persisted in the database 228 and/or local cache 216 with attributes like the charging station, vehicle, driver identity when available, energy requested, personalized charging parameters, or the like. In certain aspects, the charging site may be operated using the charging session data stored in the database 228 and/or local cache 216 (at the edge computing device) when, for example, an internet connection between the edge computing device and a cloud computing system (e.g., the cloud environment 104) is interrupted.

With information on current active sessions, the edge session manager 238 may run optimization algorithms to distribute available electrical capacity across charging stations 112 in line with site policies. For example, charging rates for each vehicle may be dynamically adapted to meet changing constraints like renewable energy availability or to prioritize based on driver needs. Updated target charging parameters can be continuously dispatched to connected charging stations 112.

The edge session manager 238 may use locally cached data and rules to maintain site operation integrity during network outages. For instance, predefined policies (e.g., predefined communication outage policies) may dictate how to handle new session requests, payment systems, prioritization, and existing sessions when offline. Key metrics like usage statistics and diagnostics still may be collected and stored locally. In certain aspects, two-way data synchronization occurs between the edge session manager 238 and cloud-based services provided by the cloud environment 104 when connectivity allows. This connectivity may include pushing session telemetry up to the cloud environment 104 and pulling down updates like new drivers, software upgrades, configuration changes, or the like. However, the edge environment 102 and the charging stations 112 may continue functioning even without this connectivity. By intelligently handling session and charging logic at the edge environment 102, EV charging infrastructure may realize benefits like outage resilience, improved performance, efficient multi-vehicle power balancing, machine learning-driven optimization, integration with on-site systems, or the like.

### Hardware Configurations for Edge Environment

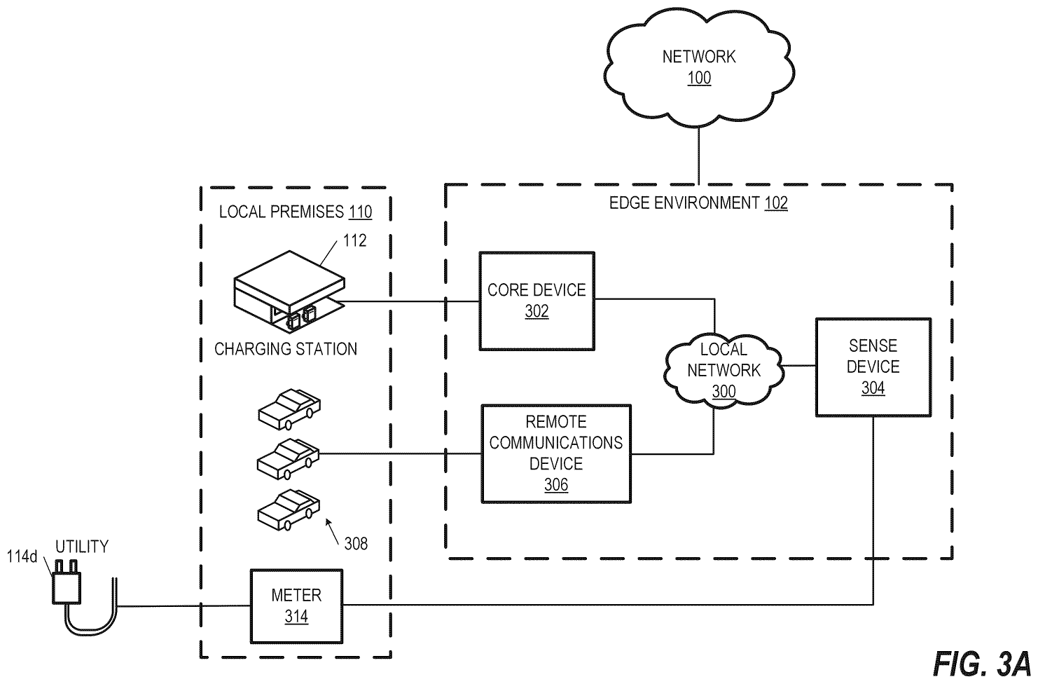

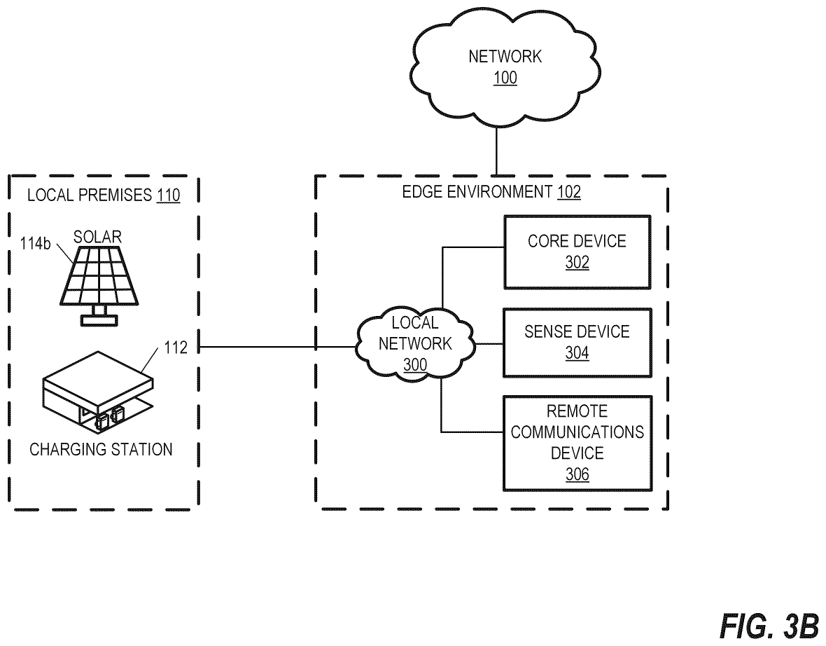

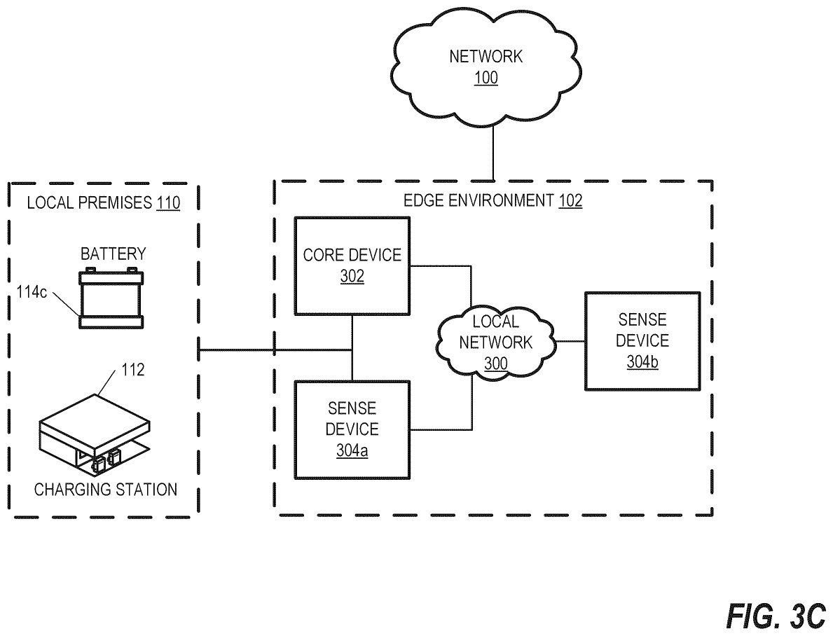

FIGS. 3A-3C depict example hardware configurations for the edge environment 102, according to aspects provided herein. Specifically, FIG. 3A depicts a charging solution. As illustrated, the charging station 112 is coupled to a local network 300 via core device 302. The local network 300 may include any local area network, Ethernet, personal area network, etc., as described above with reference to the network 100 from FIG. 1. The core device 302 may be physically installed within communications range of the chargers in the charging station 112. A sense device 304 may be installed, for example, in an electrical room or in another enclosure with electrical equipment of the charging station 112 to monitor the main metering point for the local utility point of common coupling. This enables algorithms to provide the optimal dispatch of EV charging power, subject to local energy rates and the vehicles currently charging. In the case that there are vehicles 308 using EV chargers that are out of communications range of the core device 302, such as at a sub-level of a parking garage, a remote communications device 306 may be included.

In the aspect of FIG. 3A, the core device 302 is the central processing device and serves as the communications hub. The core device 302 may provide optimization, load management, communication coordination, and data historian services. The core device 302 communicates with the cloud environment 104 to get the latest optimization and load management set points for charging stations 112 and other assets. As such, the core device 302 dispatches these set points, through a local communications protocol (e.g., Wi-Fi) and/or via the remote communications device 306 to reach locations that are distant or hard to reach, such as charging stations for vehicles 308 at sub-levels of a parking garage or a rooftop solar inverter. The core device 302 additionally collects data directly from energy sources 114 or through cloud-based communications with the network 100.

Power and energy metering data may be collected via the sense device 304. The sense device 304 may include a smart meter 314 (e.g., connected to utility 114d) with support for multiple single-and three-phase loads with a local historian and Ethernet communication back to the device via the local network 300. It should be noted that additional sense devices 304 and/or remote communications devices 306 can be added to handle situations, such as a separate subpanel for energy metering of a new solar or for monitoring of a new inverter associated with a rooftop solar installation.

FIG. 3B depicts a solar application where the core device 302 and the sense device 304 are installed in the facility's electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as the corresponding devices depicted in FIG. 3A.

FIG. 3C depicts a battery application where the core device 302 and the sense device 304 are installed physically near a battery 114c storage installation. In cases where the battery 114c is near the point of common coupling with the utility 114d, a single sense device 304a can monitor the full site. In cases where there is a significant distance to the metering point for the utility 114d, a second sense device 304b (or a plurality of second sense devices 304b) may be installed near the utility meter, such as the electrical room.

### Hardware for Devices

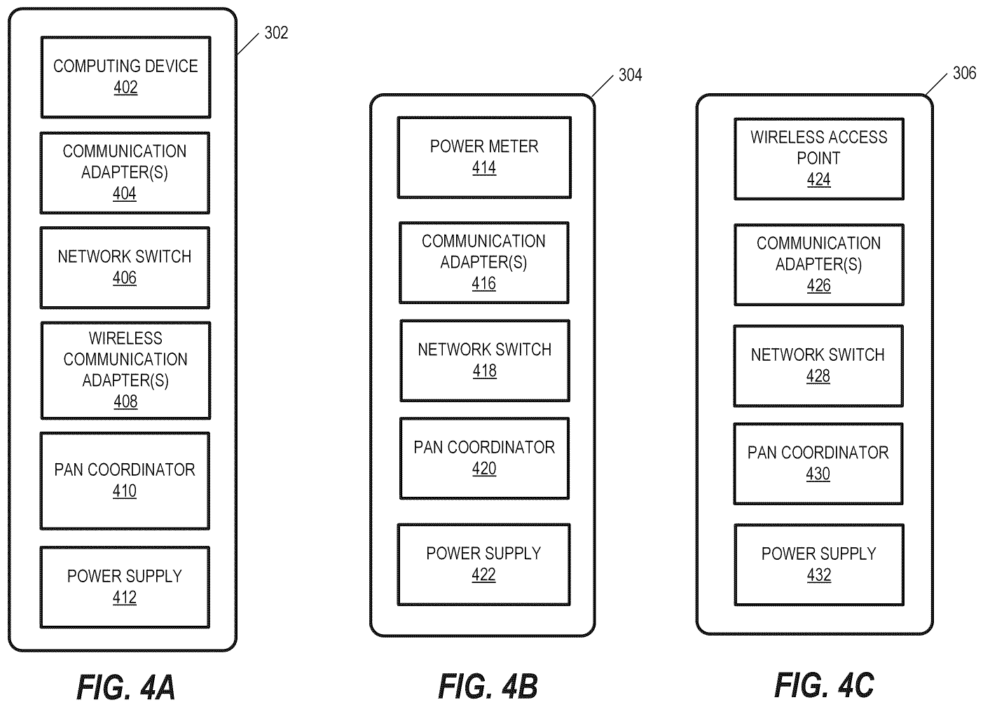

FIGS. 4A-4C depict hardware that may be utilized for the devices from FIGS. 3A-3C, according to aspects provided herein. Specifically, FIG. 4A depicts hardware components that may be present in a core device 302. In some aspects, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408 (or more than one), a PAN coordinator 410, and a power supply 412. As will be understood, the computing device 402 may include one or more processors, one or more memories, and/or other components that a normal, specific purpose machine may utilize. In some aspects, the computing device 402 may include programmable logic control (PLC) infrastructure, while some aspects may utilize personal computer components for optimization, load management, communication coordination, and/or historian services.

The communication adapter(s) 404 may be configured for load balancing and otherwise managing communications. The network switch 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator 410 may be configured to create and/or join communication connections with other devices. This may include a Zigbee coordinator, Bluetooth device, and/or other device for performing this function. The power supply 412 may be configured as a battery power, power port, etc.

FIG. 4B depicts hardware components of the sense device 304 from FIGS. 3A-3C. The sense device 304 may be configured as a smart-metering piece for collection and storage of power/energy data. The core device 302 may include a smart meter with, for example, about 15-30 channels that can monitor both single-phase circuits and three-phase circuits. The sense device 304 may communicate meter data back to the core device 302 from meter locations such as electrical rooms, rooftop solar installations, EV chargers, subpanels, or the like. These aspects may be optimized for ease of installation and reduced intrusion to the site where power over Ethernet (PoE) suffices for most installations from the core device 302. The sense device 304 may transmit data back to the core device 302 via a POE switch.

As illustrated in FIG. 4B, the sense device 304 includes a power meter 414, a communication adapter 416 (or more than one), a network switch 418, a PAN coordinator 420, and a power supply 422. The power meter 414 may be utilized for monitoring single-phase and three-phase loads of power. The communication adapter(s) 416 may be utilized for facilitating communications between the sense device 304 and other devices. The network switch 418 may be a PoE (or other network protocol) switch for communication. Similarly, the PAN coordinator 420 may create and/or join personal area networks, such as via Zigbee, Bluetooth, and the like. The power supply 422 may include a power interface for providing power to the sense device 304.

As illustrated in FIG. 4C, the remote communications device 306 is a network-connectivity extension, primarily for EV charging or solar monitoring locations where Zigbee, Wi-Fi, or Ethernet is being extended to remote or difficult-to-reach locations such as remote subpanels, parking garage levels, or rooftop inverters. Some aspects are optimized for ease of installation and reduced intrusion to the site where PoE suffices for most installations from the core device 302. The remote communications device 306 may be configured to transmit data back to the core device 302 via the network switch.

Specifically, the remote communications device 306 may include a wireless access point 424, a communication adapter 426 (or more than one), a network switch 428, a PAN coordinator 430, and a power supply 432. The wireless access point 424 may be configured to extend wireless communication signals to chargers and/or other intelligent electronic devices. The communication adapter(s) 426 may be configured for facilitating communications between the remote communications device 306 and other devices. The network switch 428 may be configured as a PoE Ethernet switch and/or other network switch for communicating with the core device 302. The PAN coordinator 430 may be configured to create and/or join personal area networks, such as via Zigbee, Bluetooth, and the like. The power supply 432 may include a power interface for providing power to the remote communications device 306.

### Edge Session Manager

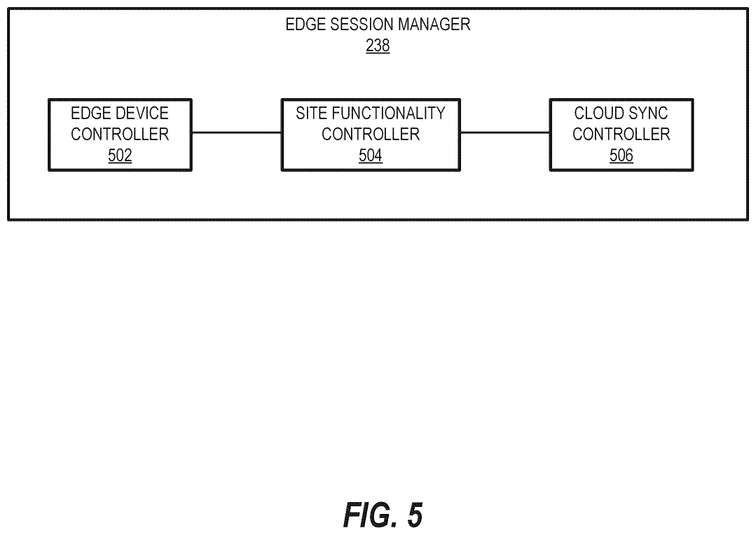

FIG. 5 depicts additional details of the edge session manager 238 in accordance with examples of the present disclosure. The edge session manager 238 can be a software component responsible for managing electric vehicle charging sessions at a charging level. In certain aspects, the edge session manager 238 includes at least three components for performing site management functions: edge device controller 502, site functionality controller 504, and cloud synchronization controller 506.

In certain aspects, the edge device controller 502 can directly control connectivity and charging behavior across individual charging stations 112. In certain aspects, the edge device controller 502 can maintain a real-time status index of one or more charging ports, tracking variables like connection state, vehicle identity, diagnostic codes, electricity dispensed, alerts, anomalies, or the like. In certain aspects, the edge device controller 502 can further assign unique local session IDs for every charging event. Optimized target charging parameters can be continuously streamed to connected charging stations 112.

In certain aspects, business logic for handling different operational scenarios rests with the site functionality controller 504. The site functionality controller 504 may support functionality like payment integration, access control, load balancing, solar coordination, outage degradation modes, and other site-specific capabilities. For example, predefined policies may determine how to process new session requests or adjust active sessions based on energy availability when offline or otherwise not connected to the cloud environment 104. The configuration, constraints, and priorities for a site may be managed by the site functionality controller 504.

In some aspects, integrating session handling at the edge environment 102 enables safer experimentation and tuning. The site functionality controller 504 may allow the edge environment 102 to test or phase in new charging behaviors, pricing models, prioritization schemes, and algorithms at individual locations while monitoring impact. Sites can serve as tailored innovation hubs before changes roll out system-wide, for example, as provided by the cloud environment 104.

In certain aspects, the cloud synchronization controller 506 facilitates two-way data synchronization to maintain consistency between the cloud environment 104 and the edge environment 102. Usage, diagnostic, and session telemetry data can be provided from edge environment(s) 102 to cloud environment(s) 104 for aggregation, analysis, and billing. Pricing updates, access control revisions, software patches, model improvements, and configuration tweaks can be pushed in reverse (e.g., from cloud environment 104 to edge environment 102). A transactional change log can help resynchronize after prolonged disconnects and/or outages.

In certain aspects, charging stations 112 transmit status notifications like vehicle connect and disconnect events, electricity dispensed, errors, warnings, or the like to the edge device controller 502 via local networking. This real-time charging station 112 feedback may enable the edge session manager 238 to update sessions, adapt charging curves, flag issues quickly, or the like. Temporary caching and transmission buffers may allow the system to track this fast-changing data from large charging station fleets. In certain aspects, the edge session manager 238 can leverage a local persistent session store (e.g., local cache 216) for resilience. Active and recently completed charging events may be maintained in an embedded database such as with descriptive attributes, usage details, processed statistics, or the like. Keeping this historically complete record of site activity within the edge environment 102 may allow charging management functionality to proceed during cloud service outages and also reduce data duplication and transit costs.

In certain aspects, on-site analytics and reporting provide actionable business insights using only edge resources. Data mining algorithms may generate visualizations covering load shaping, solar utilization, driver behavior, clustering, predicted demand, electrical constraints, anomaly patterns, degradation modeling, other operational analytics, or the like. Integrating analytical intelligence directly at the edge environment 102 may allow identifying and responding to issues rapidly while reducing edge-to-cloud data transmission costs.

The edge session manager 238 can also enable independent upgrades. For example, new charging station models can be integrated without impacting existing functionality of the site 110. Site-specific policies, pricing schemes, access roles, and business logic can also be handled by the edge session manager 238 rather than needing software or configuration changes across all installations. Adding machine learning capabilities to optimize charging schedules can also occur semi-independently based on defined interfaces between components.

### Architecture and Logic for Edge Session Manager

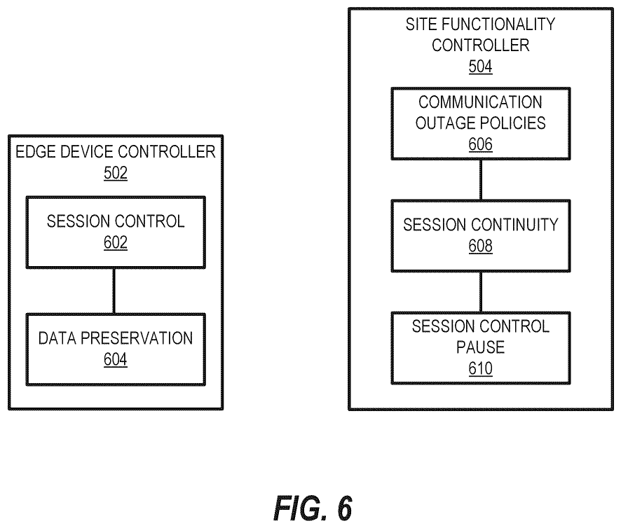

FIG. 6 depicts internal architecture and logic included within two main components of the edge session manager 238: the edge device controller 502 and the site functionality controller 504. In certain aspects, these controllers work together to enable local charging management. As shown, the edge device controller 502 includes session control module 602 and data preservation module 604, and directly interacts with connected charging stations 112 to monitor availability and control active charging sessions. The session control module 602 initiates and terminates sessions based on real-time EV connection status events received from charging stations 112. Details on in-progress charging events can be stored locally via the data preservation module 604. This persisted information allows sites to operate through network outages. In some examples, the data preservation module 604 may interact with local cache 216 and/or database 228 to store such information.

The site functionality controller 504 includes predefined communication outage policies 606, session continuity module 608, and session control pause module 610, and manages specific site operating conditions and constraints. In certain aspects, when connectivity to the cloud environment 104 is lost or degraded, charging at one or more charging sites 110 can continue based on the predefined communication outage policies 606. For example, a workplace charging site may continue to enable access to charging session only to registered employees during an outage. The session continuity module 608 works to maintain, adapt, or stop existing charging sessions depending on different outage scenarios. Some sites may adjust charging rates dynamically based on current solar production or energy needs that can be tracked on-site while operating disconnected from the cloud environment 104. The session continuity configurations can work to balance driver experience, electrical constraints, and business goals.

Depending on circumstances, the session control pause module 610 can actively throttle back or halt charging session activity when disconnected from the cloud environment 104. For instance, large public charging sites that rely on cloud payment integrations and access control rules may disable establishing new sessions during disconnects while allowing active charging to finish. These degradation policies may help transition sites from normal to reduced offline functionality.

When online functionality is restored, the cloud synchronization controller 506 (e.g., of FIG. 5) may resume bi-directional data transfer. Usage statistics and session telemetry captured during the disconnected period may be provided to cloud environment 104 for aggregation and billing while software updates can be pulled downstream, for example, as part of a resynchronization process. In some examples, a transactions journal aids the resynchronization process across the recent past to account for any informational gaps. The cloud synchronization controller 506 (e.g., of FIG. 5) may communicate directly with one or more of the edge device controller 502 and/or the site functionality controller 504 to relay communication state information.

### Cloud Environment

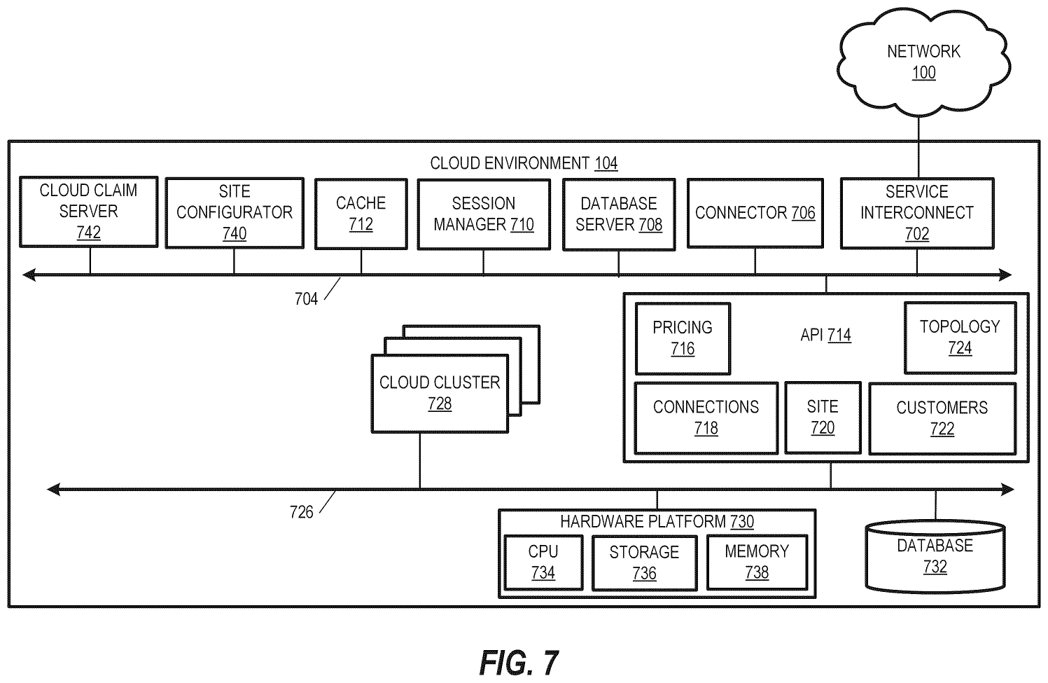

FIG. 7 depicts a cloud environment 104 for managing electric vehicle charging sessions and related data, according to aspects provided herein. As illustrated, the network 100 may couple to the cloud environment 104 via a service interconnect 702 that corresponds with the service interconnect 224 from FIG. 2. Similar to the service interconnect 224 from FIG. 2, the service interconnect 702 may be configured to facilitate an HTTP, TCP, and/or other communication portal through the network 100 to the edge environment 102 for the exchange of data between the edge environment 102 and the cloud environment 104. The service interconnect 702 is also coupled to a communication bus 704, which facilitates communication among various components of FIG. 7. Also connected to the communication bus 704 are a connector 706, a database server 708, a session manager 710, a cache 712, an application programming interface (API) 714, a site configurator 740, and a cloud claim server 742. The API 714 may include a pricing API 716, a connections API 718, a site API 720, a customers API 722, and a topology API 724. The API 714 may be implemented by hardware platform 730. Hardware bus 726 is coupled to a cloud cluster 728, as well as the hardware platform 730 and a database 732. The hardware platform 730 may include one or more processors, such as a CPU 734, one or more storages, such as a storage component 736, and one or more memories, such as a memory component 738.

The API 714 is a component of the cloud environment 104. As such, the API 714 and its sub-components 716-724 may cause storage of and/or process site information, site topology, customers, connections to panels, constraints of panels, pricing information of each site, etc. The API 714 may also serve as a mobile backend by storing personal information of charge users (e.g., email, charging preferences, payment preferences, privileges, access, fleet information, etc.). The API 714 may additionally store peak charging configurations, data related to meter setup, etc.

When a vehicle is plugged into a charging station 112 (of FIG. 1), the edge session broker 218 (of FIG. 2) may communicate connection information to the API 714. The connection information may include vehicle information, user information, charging station information, etc. The API 714 then creates a charge session object, which is stored in the cache 712. The cache 712 sends session data, along with topology constraints and the charge session object to the edge environment 102. The connector 706 may additionally cause the cloud cluster 728 to maintain the charge session object for retrieval by an interested party. As the session continues, the session manager 710 may be utilized to alter constraints of the session, which may cause the cloud cluster 728 to update the charge session object.

When a user claims a previously created session with the mobile device 114c, the database server 708 may create a database entry with the charge session, driver, along with energy request, willingness to pay, electricity purchased, etc. The connector 706 may update the cloud cluster 728 with the database entry. This data may then be sent to the edge environment 102. When the charge session ends (e.g., the vehicle is unplugged), that action will be added to the database entry and the database entry may be moved from a current sessions list to a completed sessions list.

As indicated above, the hardware platform 730 may represent hardware that may be utilized to execute the components described regarding FIG. 7. As such, the CPU 734 may be configured as any processing unit for receiving and executing computer-readable instructions. The storage component 736 may be configured as any hard drive or other local storage device. The memory component 738 may be configured as any type of RAM, ROM, registers, etc. or the like.

The cloud claim server 742 may enable drivers to reserve and configure future charging sessions remotely via interfaces like mobile applications. The cloud claim server 742 may provide a platform for off-site session initiation when connectivity permits. The cloud claim server 742 may complement the on-site claim service 236 (of FIG. 2) which handles requests originating from the charging location itself.

Driver-initiated charging claims may reach the cloud claim server 742 through internet-based client apps, websites, vehicle telematics integrations, or the like. Information supplied typically includes driver identity, location, specific station desired, energy amount required, arrival time, any special charging parameters, or the like. The component validates details against access policies. The cloud claim server 742 can assess charging infrastructure availability across charging sites 110 to find availability and approve reservations. The cloud claim server 742 can check for conflicts with existing bookings maintained in a master session inventory. After validating, the cloud claim server 742 can issue a verified claim check to the requesting end-user application. The details of the claim can then be provided to a site's claim service 236 (of FIG. 2) through the edge environment 102. This prepares site 110 for the future session so charging and space capacity can be reserved. Then, upon actual driver arrival and vehicle connection, the edge session manager 238 (of FIG. 2) may activate charging according to the pre-lodged specifications. By facilitating remote access, the cloud claim server 742 may allow drivers to not only initiate but also customize and adjust sessions on-the-fly through their personal apps.

### Sequence Diagram for Managing EV Charging Sessions

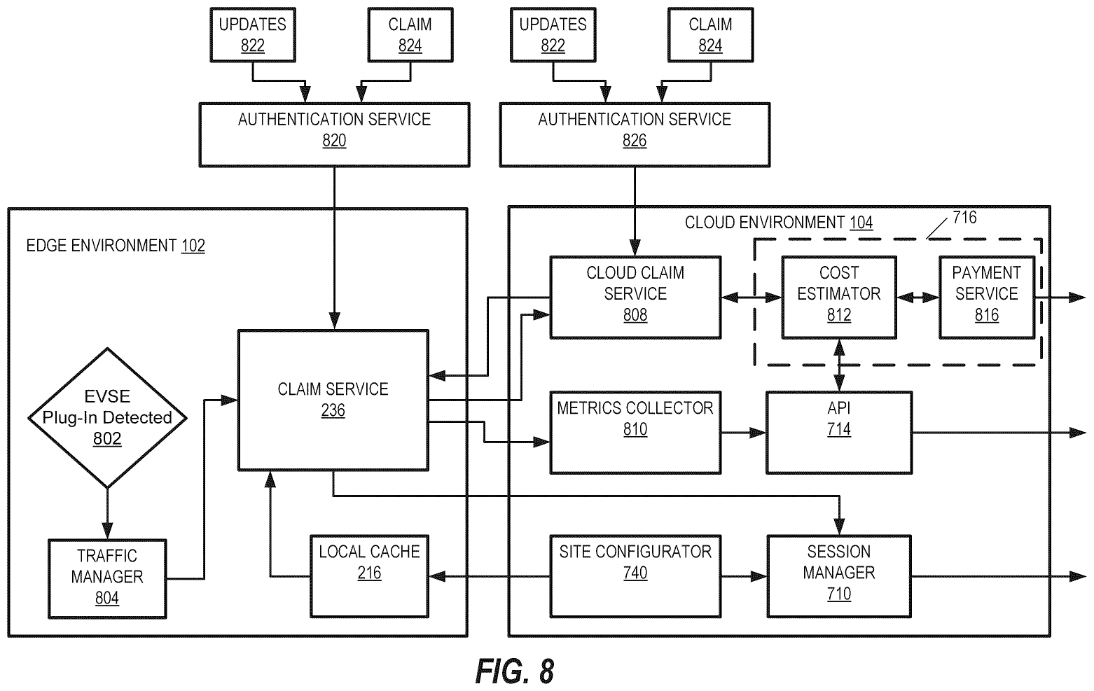

FIG. 8 depicts a sequence diagram spanning cloud and edge environments that enable drivers to remotely initiate, claim, and manage EV charging sessions. As depicted in FIG. 8, one or more components may communicate with other components across environments (e.g., cloud environment 104 and edge environment 102) to coordinate charging session.

When connectivity between the edge environment 102 and the cloud environment 104 is not an issue, a driver can plug their electric vehicle into a charging station to trigger a detection at 802 such that a charging station sends a connection status notification message to traffic manager module 804 in the edge environment 102. This alerts the edge environment 102 that a new vehicle is connected and available for a potential charging session. In response, the traffic manager module 804 can invoke claim service 236 to initiate a validated session. The claim service 236 can verify charging details against site configuration policies which can be accessed via the site configurator 740 (e.g., of FIG. 7). In some examples, the driver identity and access permissions can be checked using a cloud claim service 808 which may be provided by the cloud claim server 742 of FIG. 7 in the cloud environment.

Once a legitimate claim is validated, the cloud claim service 808 can make a request via the session manager 710 to activate charging parameters for a charging station 112. Such parameters can include, but is not limited to, charging current levels, excess energy limits, durations, and other boundary constraints.

The session manager 710 can provide a copy of the active session details to the local cache 216. The session manager 710 can also register corresponding usage and telemetry data with the metrics collector 810 as the charging session proceeds. Such data can eventually be matched and processed in cloud environment 104 for accurate billing. As the vehicle charges, additional contextual updates like payment authorization triggered through payment service 816 and supplementary data can provide additional contextual information about the session, where such information can be stored in the local cache 216. In some examples, a cost estimator 812 may provide estimated costs about the active session to the cloud claim service 808. For example, as the vehicle draws charge, usage telemetry and metrics are logged locally via the local cache 216 as well as synchronized up to the cloud environment 104.

When the driver disconnects the vehicle from the charging station 112, the charging station notifies the traffic manager module 804 that the session has ended. This notification results in the termination of the local session, where final tallies and updates can be synchronized to the usage and billing systems in the cloud environment 104.

In some examples, a driver can plug in their electric vehicle to a charging station 112, triggering a connection status notification to the traffic manager module 804 per normal operation. However, when the claims service 236 or session manager 710 attempts to validate the session or driver access credentials against the cloud claim service 808, or other cloud-based services, the requests may time out. After a predetermined number of failed attempts over a certain time of period, the edge environment 102 can recognize that the connectivity to the cloud environment 104 has been lost and switches into outage operating mode.

For an already claimed charging session, the existing details stored in the local cache 216 allow the claim service 236 to directly activate charging rather than needing to re-verify with session manager 710 or cloud claim service 808. However, the metrics data is logged locally rather than synchronized with cloud usage and billing systems since they are unreachable.

As the vehicle charges, additional payment authorizations or entitlement checks are also skipped since cloud services are offline. Instead, the charging session continues per the access rules and parameters cached locally for the site and driver. When the EV disconnects, the traffic manager module 804 logs the session stop status event, though it cannot propagate the completed details to the cloud environment 104. Without connectivity, the edge environment 102 continues operating from the local cache 216 based on previously provided site configuration information from the site configurator 740. Already claimed sessions proceed but new claims may be disabled.

Once connectivity is restored, components like the cloud synchronization controller 506 (of FIG. 5) initiate bi-directional synchronization to bring cloud and edge session stores up to date. This includes pushing up logged usage data or information and resuming access control checks against restored identity services. Pending claims queued during the outage can also now get authorized and activated.

The authentication services 820 and 826 enable identity verification and access permissions to be checked when drivers and vehicles connect to the cloud claim service 808 and/or the claim service 236. These services integrate organization member lists, access codes, individual account credentials, and/or other policy stores to approve session requests and gate interactions with cloud environment components. In some examples, a driver may claim 824 a session through a kiosk, RFID, mobile app, website, etc., where claims made to the mobile app and/or website may be routed to the cloud environment 104. In some examples, potential updates 822 can be made to access privileges, site configurations, pricing data, or other session-impacting data synchronized from the cloud environment 104 to the edge environment 102.

### Data Structures

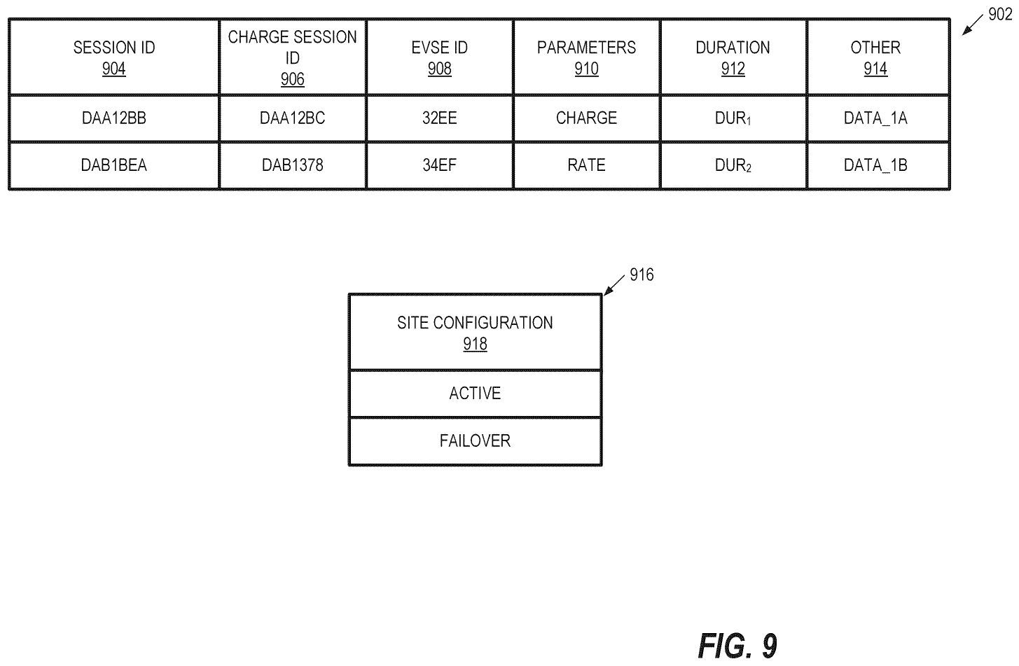

FIG. 9 depicts example data structures 902 and 916 in accordance with aspects of the present disclosure. The data structure 902 can be used to represent technical charging session parameter values and constraints. This may include fields such as, but not limited to, session ID 904 that uniquely identifies a given charging session across the edge environment 102 and the cloud environment 104; a charge session ID 906 that is a distinct identifier representing a charging event, enabling tracing usage details like energy dispensed; an EVSE ID 908, identifying the specific electric vehicle supply equipment port used for the charging session; one or more parameters 910 including information for the charging behavior specifications like rates, limits, priorities as represented in data structure 902; charging duration 912, which can track both the initially requested and actual elapsed charging duration for the session; and other information 914 which may include information or other context about the charging session. For example, other information 914 may include a charge rate specifying target power transfer levels over time, such as a 20 kW to 80 kW ramp over 30 minutes; one or more priority tags that indicate relative session prioritization tiers, like “High”, “Medium”, “Low”; and/or excess allocation information that defines allowable variability buffers before capping supply, for example +/−5 kW. By storing such information in data structure 902, active charging behavior can be optimized dynamically as vehicle power demands change, even without connectivity to the cloud environment 104.

The site configuration data structure 916 may include site configuration information 918, which may include operating mode, pricing plan, and access control lists. For example, the site configuration data structure 916 may include operating mode information that sets location rules regarding authentication needs, payment collections, and/or open access levels; and pricing plan information that defines the default dollar per kWh rates plus relevant fees used for driver cost estimates, one or more access control lists that specifies allow/deny filters based on groups, vehicle types, credentials, etc. Caching data structures 902 and 916 in the local cache 216 can facilitate uninterrupted charging site functionality during connectivity outages by maintaining session and configuration details at the edge environment 102.

### Process for Managing EV Charging Sessions Utilizing an Edge Device

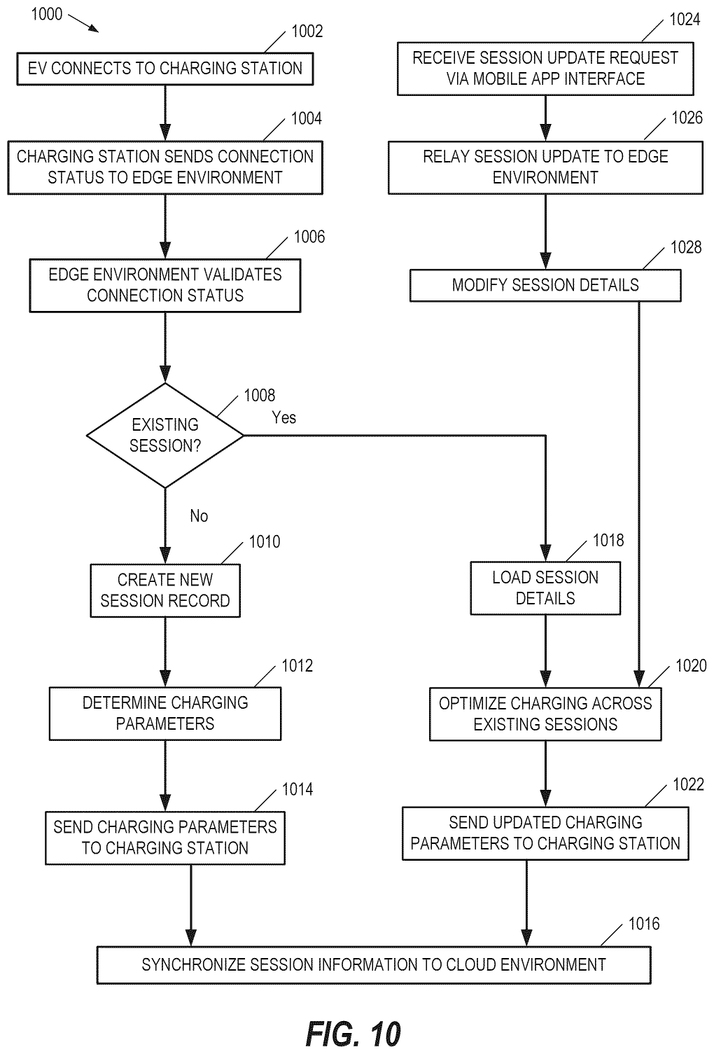

FIG. 10 depicts a flowchart illustrating an example method 1000 for managing electric vehicle charging sessions utilizing an edge computing system architecture, according to aspects of the present disclosure. As previously described, in certain aspects, the edge environment 102 can perform one or more management functionalities including monitoring connected stations, initiating and tracking charging sessions, optimizing electricity allocation across vehicles, and/or maintaining operations at a charging site 110 (of FIG. 1).

In step 1002, an EV connects to a charging station 112 (of FIG. 1) at the charging site 110.

Responsive to detecting this new EV connection, in step 1004 the charging station 112 sends an EV connection status notification message to the edge environment 102 (of FIG. 1). For example, the notification may be sent over a local wireless network from the charging station 112 to the edge environment 102.

Upon receiving the EV connection status notification, in step 1006 the edge environment 102 validates the connection status to confirm that an EV has successfully connected to the identified charging station 112.

In step 1008, the edge environment 102 checks its local data store (e.g. local cache 216 of FIG. 2) for an existing charging session record corresponding to the newly connected charging station 112.

If it is determined that no existing session record exists, this is a new EV connection, and in step 1010 the edge environment 102 initiates a new charging session, which includes creating a new session data record persisted in the local data store.

In step 1012, the edge environment 102 determines optimized charging parameters for the newly connected EV based on factors such as detected EV capabilities, charging site rules and configurations, priorities, electricity rates, and availability constraints.

In step 1014, the edge environment 102 sends the determined optimized charging parameters from step 1012 to the charging station 112. This initiates charging of the connected EV according to the optimized charging parameters. As previously described, such charging parameters may include attributes such as target charging current levels, excess allocation definitions, priority tags, and/or charging time duration limits.

As the new charging session proceeds, in step 1016 usage statistics and metrics are logged locally in the local cache 216 (of FIG. 2) of the edge environment 102. This data enables analytics, diagnostics, and/or synchronization with the cloud environment 104 when connectivity permits. Further, the edge environment 102 can synchronize newly initiated session information to the cloud environment 104 (of FIG. 1) by sending a session update message. However, this external connectivity is not required to establish or control the EV charging session itself.

As previously described regarding step 1008, the edge environment 102 checks its local data store (e.g. local cache 216) for an existing charging session for the charging station 112 where the EV connected. If an existing session is found, the method 1000 proceeds to step 1018 where the edge environment 102 loads session details from a persisted record from local cache 216. Details like the driver identity, requested energy, original optimized charging parameters, timestamps, and/or other attributes are retrieved.

In step 1020, the edge environment 102 runs optimization algorithms to rebalance and allocate electrical capacity across all existing charging sessions. For example, an increase may have been requested for the current session's charging rate based on the EV's battery needs. So other sessions' rates can be adjusted accordingly per site distribution constraints. Outputs from the optimization in step 1020 include updated target charging parameters for each active session, including the newly connected EV.

Proceeding to step 1022, these updated optimized charging parameters are provided by the edge environment 102 to the charging stations 112 that manage the affected sessions. This controls the charging stations 112 to deliver electricity to respective EVs according to the revised optimization outputs. For example, charging current levels may be increased or dynamically throttled based on other site needs. As charging proceeds under the updated parameters, usage statistics and metrics continue to be locally logged by the edge environment 102. Data like energy dispensed is tracked for analytics, diagnostics, billing, and synchronization. In step 1016, the edge environment 102 can synchronize the latest charging session information including new parameters, usage data, and statistics to the cloud environment 104 now that optimization has completed.

The optimized charging parameters provided to the charging stations allow precise management of electricity provisioning behavior over time. For example, charging current (e.g. amperes) levels may be adapted based on changing renewable availability and vehicle demand across multiple active sessions. Charging power ramp rates can also be customized, like gradually increasing supply (e.g., every 30 minutes) to avoid spikes. Duration budgets can automatically time-limit vehicle charging when EV demand is high. Excess allocation definitions let charging stations know acceptable upper and lower supply thresholds. Priority tags directly indicate relative charging precedence across vehicles. By continually fine-tuning these output parameters and constraints, charging fulfillment aligns with certain goals, policies, constraints while still maximizing usage.

In step 1024, an update request may be received for the active charging session, such as a driver modifying their requested session duration or charging parameters via a mobile application interface.

In step 1026, this request is relayed from the mobile application by the cloud environment 104 to the edge environment 102.

The details of the impacted active sessions are modified at step 1028.

The edge environment 102 can then re-optimize charging across existing sessions based on these updates at 1020.

Updated charging parameters are dispatched to charging stations 112 to implement the changes at 1022.

The method 1000 completes when the vehicle disconnects from the charging station 112 and the respective session is terminated. Metrics and statistics collected of the session are maintained by the edge environment 102 for analytics, diagnostics, and synchronization to the cloud environment 104 during future connected periods.

Process for Managing Charging Station Functionality during Outages

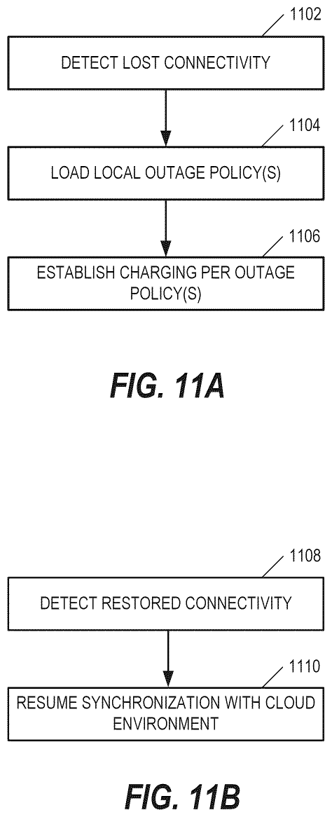

FIGS. 11A and 11B depict flowcharts illustrating example methods for managing charging station functionality during network communication outages according to aspects of the present disclosure. As introduced earlier, one or more components of the edge environment 102 can monitor and control EV charging operations even when connectivity to the cloud environment 104 is lost.

Beginning with FIG. 11A, in step 1102 the edge environment 102 (of FIG. 1) detects an interruption in network communications for one or multiple services provided by the cloud environment 104 (of FIG. 1). This disconnected state may occur due to, for example, an internet service provider (ISP) outage, cellular disruption, cyber-attack, or other connectivity failure external to the charging site 110 premises (of FIG. 1).

In step 1104, upon detecting said communication loss to external support systems, the edge environment 102 references local site data and policies stored on-site that dictate how to operate the charging stations 112 (of FIG. 1) during such error conditions. Predefined degradation modes and backup settings provide station control continuity even when communication between the edge environment 102 and the cloud environment 104 is interrupted. Different outage scenarios may have unique degradation policies specified. For example, minor connectivity blips may throttle back non-critical monitoring while retaining full charging capabilities. In contrast, a region-wide ISP failure may halt all new session creation but permit active sessions to finish.

As an example policy, in step 1106 charging stations 112 may continue providing active charging services to EVs currently connected, while disabling processing of new session requests until connectivity is restored. Drivers with existing sessions may experience no interruptions, while new drivers may see request failures. Charging stations 112 may actively throttle back or completely stop providing charging current to connected electric vehicles depending on severity of communication outage scenario. Prioritization, pricing adjustments, solar coordination, and other logic also adjusts per specified offline rules. Prioritization logic may dictate that sessions for emergency vehicles get charging access prioritized during an outage, while employee and guest sessions are temporarily suspended. Charging sites 110 may also cycle through connected EVs by time limits if electricity availability is reduced. Site usage and diagnostics data may continue to be logged locally at the edge environment 102. That is, without connectivity to cloud analytics systems, usage and diagnostics data including charging station status, errors, and electricity dispensed can continue to be logged locally for subsequent synchronization.

Moving to FIG. 11B, the edge environment 102 maintains constant monitoring for restoration of the lost network communications. When external connectivity returns, the restored connectivity may be detected at step 1108.

In step 1110, two-way synchronization of charging data can occur to bring (e.g., all) components at the cloud environment 104 and the edge environment 102 up to date. Detailed resynchronization processes can leverage transaction journals and logs to incrementally align charging session information between edge and cloud environments. The edge environment 102 can upload (e.g., all) session statistics and events logged during the outage for aggregation and billing. Software patches, configuration updates, model improvements and other data may also be downloaded from the cloud environment 104 to the edge environment 102 to catch up on any deployments that occurred during the disconnected period. With bi-directional consistency regained, normal charging operations can resume.

Process for Managing Electric Vehicle Charging Sessions

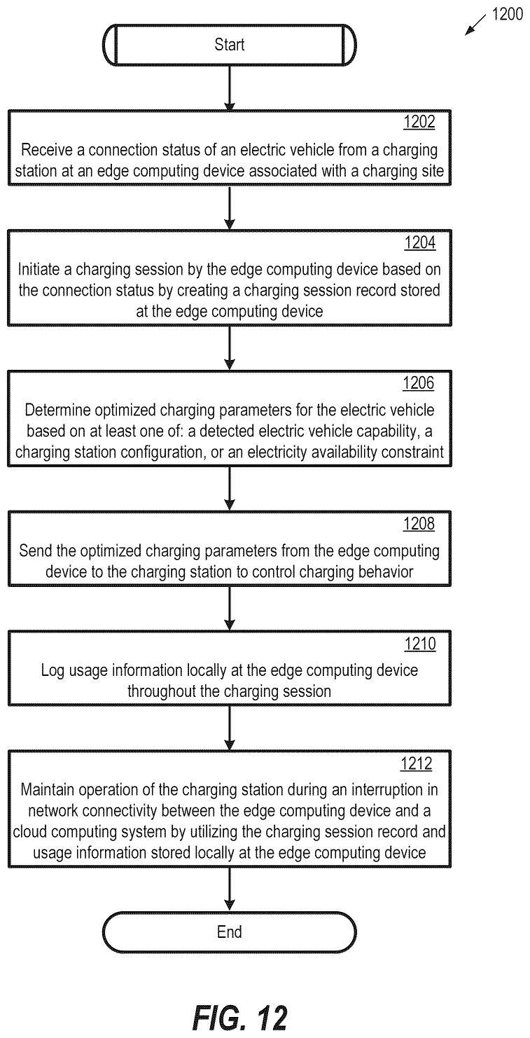

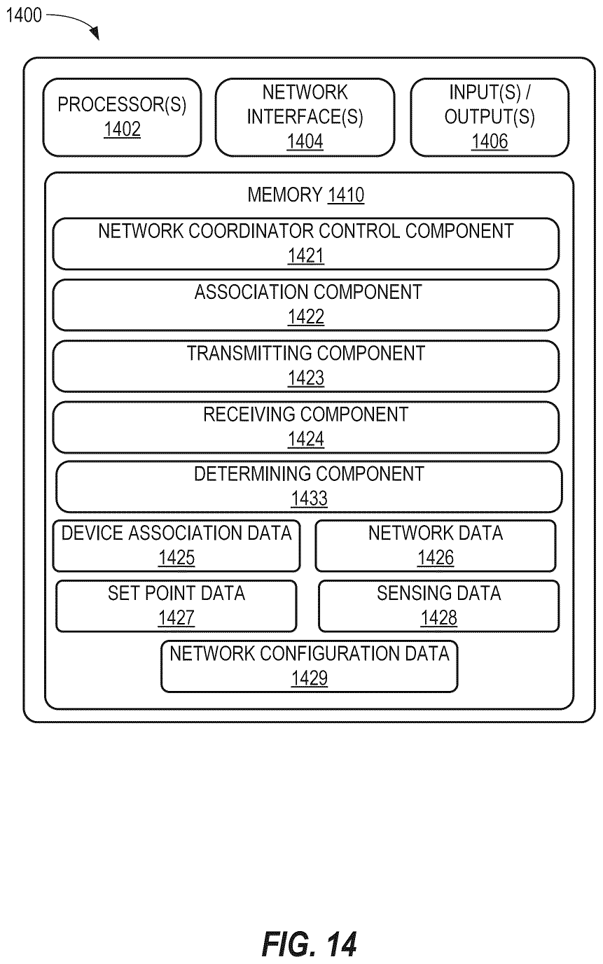

FIG. 12 depicts an example method 1200 for managing electric vehicle charging sessions according to aspects provided herein. In one aspect, method 1200 can be implemented by the edge environment 102 (of FIG. 2) and/or processing system 1400 of FIG. 14.

Method 1200 starts at block 1202 with receiving a connection status of an electric vehicle from a charging station at an edge computing device associated with a charging site, wherein the edge computing device is located on-site at the charging site.

Method 1200 continues to block 1204 with initiating a charging session by the edge computing device based on the connection status by creating a charging session record (e.g., to be) stored at the edge computing device.

Method 1200 continues to block 1206 with determining optimized charging parameters for the electric vehicle based on at least one of: a detected electric vehicle capability, a charging station configuration, or an electricity availability constraint.

Method 1200 continues to block 1208 with sending the optimized charging parameters from the edge computing device to the charging station to control charging behavior.

Method 1200 continues to block 1210 with logging usage information locally at the edge computing device of and/or throughout the charging session.

Method 1200 continues to block 1212 with maintaining operation of the charging station during an interruption in network connectivity between the edge computing device and a cloud computing system by utilizing the charging session record and usage information stored locally at the edge computing device.

In some aspects, method 1200 further includes resuming synchronization of charging data and session details between the edge computing device and the cloud computing system when the network connectivity is restored.

In some aspects of method 1200, maintaining the operation of the charging station includes allowing existing charging sessions to continue according to predefined policies stored locally at the edge computing device.

In some aspects, method 1200 further includes re-optimizing charging parameters across multiple active charging sessions based on electricity availability constraints.

In some aspects, method 1200 further includes sending updated optimized (e.g., the re-optimized) charging parameters to multiple charging stations from the edge computing device.

In some aspects of method 1200, initiating the charging session includes determining whether an existing charging session record exists based on the connection status.

In some aspects, method 1200 further includes in response to determining that no existing charging session record exists, creating a new charging session record at the edge computing device.

In some aspects, method 1200 further includes in response to determining that the existing charging session record exists, retrieving details associated with the existing charging session record and re-optimizing charging parameters for multiple active charging sessions based the details associated with the existing charging session record.

Note that FIG. 12 is just one example of a method, and other methods including fewer, additional, or alternative steps are possible consistent with this disclosure.

### Process for Managing Electric Vehicle Charging Sessions

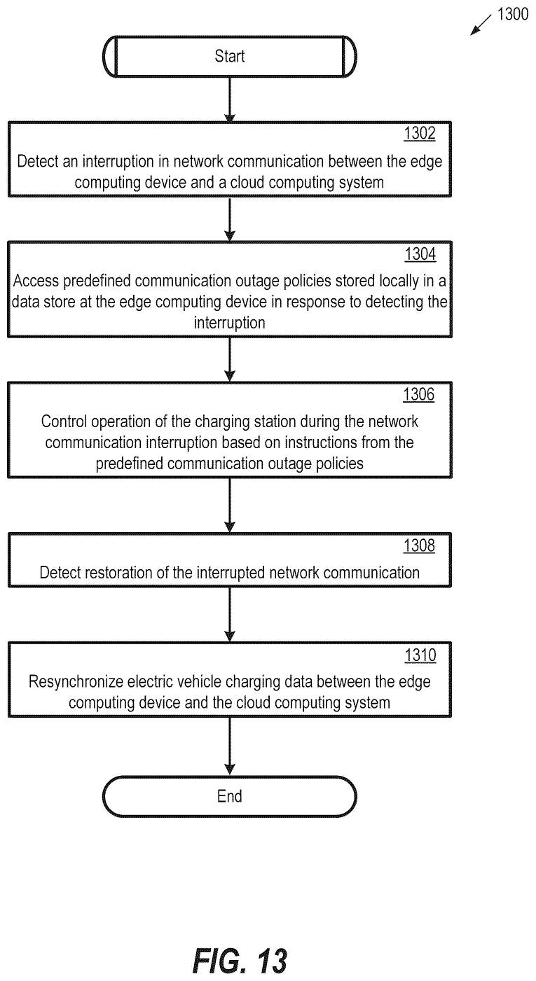

FIG. 13 depicts an example method 1300 for managing electric vehicle charging sessions according to aspects provided herein. In one aspect, method 1300 can be implemented by the edge environment 102 (of FIG. 2) and/or processing system 1400 of FIG. 14.

Method 1300 starts at block 1302 with detecting, at an edge computing device located on-site at a charging station location, an interruption in network communication between the edge computing device and a cloud computing system.

Method 1300 continues to block 1304 with accessing, by the edge computing device, predefined communication outage policies stored locally in a data store at the edge computing device in response to detecting the interruption.

Method 1300 continues to block 1306 with controlling, by the edge computing device, operation of a charging station during the interruption (e.g., network communication interruption) based on instructions included in the predefined communication outage policies.

In some aspects of method 1300, the controlling includes making determinations on at least one of: handling new electric vehicle charging session requests received during the interruption; adapting or stopping existing active electric vehicle charging sessions during the interruption; processing payments for electric vehicle charging sessions; prioritizing between multiple electric vehicle charging sessions; or logging charging station usage data and diagnostic information at the edge computing device.

Method 1300 continues to block 1308 with detecting, at the edge computing device, restoration of the interrupted network communication.

Method 1300 continues to block 1310 with resynchronizing electric vehicle charging data between the edge computing device and the cloud computing system.

In some aspects of method 1300, accessing the predefined communication outage policies includes retrieving rules indicating degradation modes that define functionality levels during detected network communication outages.

In some aspects of method 1300, controlling the operation of the charging station includes disabling processing of the new electric vehicle charging session requests while allowing the existing active electric vehicle charging sessions to continue.

In some aspects of method 1300, controlling the operation of the charging station includes throttling electric vehicle charging speeds or stopping electric vehicle charging entirely depending on (e.g., based on) a communication outage scenario assessment.

In some aspects of method 1300, resynchronizing the electric vehicle charging data (e.g., following a connectivity restoration) includes: uploading the charging station usage data and the diagnostic information, logged locally at the edge computing device during the interruption, to the cloud computing system and receiving at least one of: software updates from the cloud computing system, charging model improvements from the cloud computing system, or configuration changes from the cloud computing system.

In some aspects, method 1300 further includes using a transaction change log at the edge computing device to resynchronize electric vehicle charging session data with the cloud computing system after the interruption (e.g., following connectivity outages).

In some aspects of method 1300, controlling the operation of the charging station further includes determining electric vehicle charging parameters based on locally cached data including at least one of: operating mode details, pricing plans, or access control lists.

In some aspects, method 1300 further includes enabling remote initiation of electric vehicle charging sessions through a cloud server that interfaces with the edge computing device located at the charging station location.

In some aspects, method 1300 further includes reserving charging station and electrical capacity for a future electric vehicle charging session in response to the remote initiation and while the interruption (e.g., network communication outage) exists, activating charging according to the reserved charging station and electrical capacity for the future electric vehicle charging session once an electric vehicle electrically connects to a charging port of the charging station.

Note that FIG. 13 is just one example of a method, and other methods including fewer, additional, or alternative steps are possible consistent with this disclosure.

### Example Processing System for Managing Electric Vehicle Charging Sessions

FIG. 14 depicts an example processing system 1400 configured to manage electric vehicle charging sessions, according to aspects provided herein.

Processing system 1400 includes one or more processors 1402. Generally, a processor 1402 is configured to execute computer-executable instructions (e.g., software code) to perform various functions, as described herein.

Processing system 1400 further includes one or more network interfaces 1404, which generally provide(s) data access to any sort of data network, including personal area networks (PANs), local area networks (LANs), wide area networks (WANs), the internet, and the like.

Processing system 1400 further includes input(s) and output(s) 1406, which generally provide means for providing data to and from processing system 1400, such as via connection to computing device peripherals, including user interface peripherals.

Processing system 1400 further includes one or more memories 1410 including various components. In this example, memory 1410 includes a network coordinator control component 1421, an association component 1422, a transmitting component 1423, a receiving component 1424, a determining component 1433, device association data 1425, network data 1426, set point data 1427, sensing data 1428, and network configuration data 1429.

Processing system 1400 may be implemented in various ways. For example, processing system 1400 may be implemented as a computing device 402 within core device 302, described above with respect to FIGS. 3 and 4. Note that in various implementations, aspects may be omitted, added, or substituted from processing system 1400.

### Example Clauses

Implementation examples are described in the following numbered clauses:

Clause 1: A method for managing electric vehicle charging sessions, comprising: receiving, at an edge computing device associated with a charging site, a connection status of an electric vehicle from a charging station, wherein the edge computing device is located on-site at the charging site; initiating, by the edge computing device, a charging session based on the connection status by creating a charging session record to be stored at the edge computing device; determining optimized charging parameters for the electric vehicle based on at least one of: a detected electric vehicle capability, a charging station configuration, or an electricity availability constraint; sending the optimized charging parameters from the edge computing device to the charging station to control charging behavior; logging usage information locally at the edge computing device for the charging session; and maintaining operation of the charging station during an interruption in network connectivity between the edge computing device and a cloud computing system by utilizing the charging session record and the usage information stored locally at the edge computing device.

Clause 2: A method in accordance with Clause 1, further comprising resuming synchronization of charging data and session details between the edge computing device and the cloud computing system when the network connectivity is restored.

Clause 3: A method in accordance with any one of Clauses 1-2, wherein maintaining the operation of the charging station comprises allowing existing charging sessions to continue according to predefined policies stored locally at the edge computing device.

Clause 4: A method in accordance with any one of Clauses 1-3, further comprising re-optimizing charging parameters across multiple active charging sessions based on electricity availability constraints.

Clause 5: A method in accordance with Clause 4, further comprising sending the re-optimized charging parameters to multiple charging stations from the edge computing device.

Clause 6: A method in accordance with any one of Clauses 1-5, wherein initiating the charging session comprises determining whether an existing charging session record exists based on the connection status.

Clause 7: A method in accordance with Clause 6, further comprising in response to determining that no existing charging session record exists, creating a new charging session record at the edge computing device.

Clause 8: A method in accordance with Clause 6, further comprising: in response to determining that the existing charging session record exists, retrieving details associated with the existing charging session record; and re-optimizing charging parameters for multiple active charging sessions based on the details associated with the existing charging session record.

Clause 9: A method for maintaining electric vehicle charging station operation during network communication outages using an edge computing system, comprising: detecting, at an edge computing device located on-site at a charging station location, an interruption in network communication between the edge computing device and a cloud computing system; accessing, by the edge computing device, predefined communication outage policies stored locally in a data store at the edge computing device, wherein the accessing is in response to detecting the interruption; controlling, by the edge computing device, operation of a charging station during the interruption based on instructions included in the predefined communication outage policies, wherein the controlling comprises making determinations on at least one of: handling new electric vehicle charging session requests received during the interruption; adapting or stopping existing active electric vehicle charging sessions during the interruption; processing payments for electric vehicle charging sessions; prioritizing between multiple electric vehicle charging sessions; or logging charging station usage and diagnostic information at the edge computing device; detecting, at the edge computing device, restoration of the interrupted network communication; and resynchronizing electric vehicle charging data between the edge computing device and the cloud computing system.

Clause 10: A method in accordance with Clause 9, wherein accessing the predefined communication outage policies comprises retrieving rules indicating degradation modes that define functionality levels during detected network communication outages.

Clause 11: A method in accordance with any one of Clauses 9-10, wherein controlling the operation of the charging station comprises disabling processing of the new electric vehicle charging session requests while allowing the existing active electric vehicle charging sessions to continue.

Clause 12: A method in accordance with any one of Clauses 9-11, wherein controlling the operation of the charging station comprises throttling electric vehicle charging speeds or stopping electric vehicle charging entirely based on a communication outage scenario assessment.

Clause 13: A method in accordance with any one of Clauses 9-12, wherein resynchronizing the electric vehicle charging data comprises: uploading the charging station usage data and the diagnostic information, logged locally at the edge computing device during the interruption, to the cloud computing system; and receiving at least one of: software updates from the cloud computing system, charging model improvements from the cloud computing system, or configuration changes from the cloud computing system.

Clause 14: A method in accordance with any one of Clauses 9-13, further comprising: using, at the edge computing device, a transaction change log to resynchronize electric vehicle charging session data with the cloud computing system after the interruption.

Clause 15: A method in accordance with any one of Clauses 9-14, wherein controlling the operation of the charging station further comprises determining electric vehicle charging parameters based on locally cached data including at least one of: operating mode details, pricing plans, or access control lists.

Clause 16: A method in accordance with any one of Clauses 9-15, further comprising: enabling remote initiation of electric vehicle charging sessions through a cloud server that interfaces with the edge computing device located at the charging station location.

Clause 17: A method in accordance with Clause 16, further comprising: reserving charging station and electrical capacity for a future electric vehicle charging session in response to the remote initiation; and while the interruption exists, activating charging according to the reserved charging station and electrical capacity for the future electric vehicle charging session once an electric vehicle electrically connects to a charging port of the charging station.

Clause 18: A processing system, comprising: a memory comprising computer-executable instructions; and a processor configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium storing program code for causing a processing system to perform the steps of any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the aspects shown and described herein.

It should now be understood that aspects disclosed herein include systems, methods, and non-transitory computer-readable mediums for edge-based management of EV charging sessions. It should also be understood that these aspects are merely exemplary and are not intended to limit the scope of this disclosure.

What is claimed is:

1. A method for managing electric vehicle charging sessions, comprising:
receiving, at an edge computing device associated with a charging site, a connection status of an electric vehicle from a charging station, wherein the edge computing device is located on-site at the charging site;
initiating, by the edge computing device, a charging session based on the connection status by creating a charging session record to be stored at the edge computing device;
determining optimized charging parameters for the electric vehicle based on at least one of: a detected electric vehicle capability, a charging station configuration, or an electricity availability constraint;
sending the optimized charging parameters from the edge computing device to the charging station to control charging behavior;
logging usage information locally at the edge computing device for the charging session; and
maintaining operation of the charging station during an interruption in network connectivity between the edge computing device and a cloud computing system by utilizing the charging session record and the usage information stored locally at the edge computing device.

2. The method of claim 1, further comprising:
resuming synchronization of charging data and session details between the edge computing device and the cloud computing system when the network connectivity is restored.

3. The method of claim 1, wherein maintaining the operation of the charging station comprises allowing existing charging sessions to continue according to predefined policies stored locally at the edge computing device.

4. The method of claim 1, further comprising:
re-optimizing charging parameters across multiple active charging sessions based on electricity availability constraints.

5. The method of claim 4, further comprising:
sending the re-optimized charging parameters to multiple charging stations from the edge computing device.

6. The method of claim 1, wherein initiating the charging session comprises determining whether an existing charging session record exists based on the connection status.

7. The method of claim 6, further comprising:
in response to determining that no existing charging session record exists, creating a new charging session record at the edge computing device.

8. The method of claim 6, further comprising:
in response to determining that the existing charging session record exists, retrieving details associated with the existing charging session record; and
re-optimizing charging parameters for multiple active charging sessions based on the details associated with the existing charging session record.

9. A method for maintaining electric vehicle charging station operation during network communication outages using an edge computing system, comprising:
detecting, at an edge computing device located on-site at a charging station location, an interruption in network communication between the edge computing device and a cloud computing system;
accessing, by the edge computing device, predefined communication outage policies stored locally in a data store at the edge computing device, wherein the accessing is in response to detecting the interruption;
controlling, by the edge computing device, operation of a charging station during the interruption based on instructions included in the predefined communication outage policies, wherein the controlling comprises making determinations on at least one of:
handling new electric vehicle charging session requests received during the interruption;
adapting or stopping existing active electric vehicle charging sessions during the interruption;
processing payments for electric vehicle charging sessions;
prioritizing between multiple electric vehicle charging sessions; or
logging charging station usage data and diagnostic information at the edge computing device;
detecting, at the edge computing device, restoration of the interrupted network communication; and
resynchronizing electric vehicle charging data between the edge computing device and the cloud computing system.

10. The method of claim 9, wherein accessing the predefined communication outage policies comprises retrieving rules indicating degradation modes that define functionality levels during detected network communication outages.

11. The method of claim 9, wherein controlling the operation of the charging station comprises disabling processing of the new electric vehicle charging session requests while allowing the existing active electric vehicle charging sessions to continue.

12. The method of claim 9, wherein controlling the operation of the charging station comprises throttling electric vehicle charging speeds or stopping electric vehicle charging entirely based on a communication outage scenario assessment.

13. The method of claim 9, wherein resynchronizing the electric vehicle charging data comprises:
uploading the charging station usage data and the diagnostic information, logged locally at the edge computing device during the interruption, to the cloud computing system; and
receiving at least one of: software updates from the cloud computing system, charging model improvements from the cloud computing system, or configuration changes from the cloud computing system.

14. The method of claim 9, further comprising:
using, at the edge computing device, a transaction change log to resynchronize electric vehicle charging session data with the cloud computing system after the interruption.

15. The method of claim 9, wherein controlling the operation of the charging station further comprises determining electric vehicle charging parameters based on locally cached data including at least one of: operating mode details, pricing plans, or access control lists.

16. The method of claim 9, further comprising:
enabling remote initiation of electric vehicle charging sessions through a cloud server that interfaces with the edge computing device located at the charging station location.

17. The method of claim 16, further comprising:
reserving charging station and electrical capacity for a future electric vehicle charging session in response to the remote initiation; and
while the interruption exists, activating charging according to the reserved charging station and electrical capacity for the future electric vehicle charging session once an electric vehicle electrically connects to a charging port of the charging station.

18. A system for managing electric vehicle charging sessions, comprising:
an edge computing device associated with and located on-site at a charging station location, wherein the edge computing device comprises one or more processors configured to:
receive a connection status of an electric vehicle from a charging station;
initiate a charging session based on the connection status by creating a charging session record to be stored at the edge computing device;
determine optimized charging parameters for the electric vehicle based on at least one of: a detected electric vehicle capability, a charging station configuration, or an electricity availability constraint;
send the optimized charging parameters from the edge computing device to the charging station to control charging behavior;
log usage information locally at the edge computing device for the charging session; and
maintain operation of the charging station during an interruption in network connectivity between the edge computing device and a cloud computing system by utilizing the charging session record and the usage information stored locally at the edge computing device.

19. The system of claim 18, wherein the one or more processors are configured to resume synchronization of charging data and session details between the edge computing device and the cloud computing system when the network connectivity is restored.

20. The system of claim 18, wherein the one or more processors are configured to:
in response to determining that no existing charging session record exists, create a new charging session record at the edge computing device; and
in response to determining that an existing charging session record exists, retrieve details associated with the existing charging session record and re-optimize charging parameters for multiple active charging sessions based on the details associated with the existing charging session record.
